(19) United States
(12) Patent Application Publication
(10) Pub. No.: US 2005/0086870 A1
(43) Pub. Date: Apr. 28, 2005

(54) Diamond polishing particles and method of producing same

(75) Inventor: Noriyuki Kumasaka, Akishima (JP)

Correspondence Address: BEYER WEAVER & THOMAS LLP, P.O. BOX 70250, OAKLAND, CA, 94612-0250, US

(73) Assignee: NIHON Microcoating Co., Ltd.

(21) Appl. No.: 10/974,867

(22) Filed: Oct. 26, 2004

(30) Foreign Application Priority Data
Oct. 28, 2003 (JP) 2003-366851

(51) Int. Cl. B24D 3/02; C09C 1/68; C09K 3/14; B01J 3/06; B01J 3/08; C01B 31/06

(52) U.S. Cl. 51/307; 423/446

(57) ABSTRACT

Polishing particles are made of artificial diamond produced by a shock method, having density of 3.0-3.35 g/cm³ and including secondary particles with average particle diameter of 30 nm-500 nm. Such polishing particles are produced by firstly obtaining a product containing artificial diamond by a shock method, then subjecting this product to an acid treatment by using one or more strong acids such as concentrated sulfuric acid, concentrated nitric acid and concentrated hydrochloric acid to thereby remove impurities from and wash the product, thereafter subjecting the product to a classification process to thereby separate artificial diamond of a first kind having secondary particles with particle diameters of 30 nm-500 nm and artificial diamond of a second kind having secondary particles with particle diameters in excess of 500 nm and selecting artificial diamond of a third kind having density of 3.0-3.35 g/cm³ out of the artificial diamond of the first kind. It is the artificial diamond of the third kind that is to be used as the diamond polishing particles.

Priority is claimed on Japanese Patent Application 2003-366851 filed Oct. 28, 2003.

### BACKGROUND OF THE INVENTION

This invention relates to polishing particles dispersed inside polishing slurry and more particularly to diamond polishing particles suitable for the polishing and texturing process of a magnetic hard disc substrate as well as a method of producing such particles.

Data processors such as computers adapted to record and play back data such as characters, images and voices require an increased data recording capacity and accuracy in playback. Data are recorded magnetically on a magnetic hard disc by means of a magnetic head of a data processor and played back from such a magnetic hard disc. The recording capacity for data and accuracy in playback depend largely on the distance (the floating distance) between the surface of the magnetic hard disk and the magnetic head. In other words, the data recording capacity can be increased and the accuracy in playback can be improved if the floating distance is reduced and kept stabilized at this reduced distance. For this reason, the floating distance is required to be maintained at less than 50 nm. Recently, the floating distance is coming to be required to be less than 20 nm.

In order to stabilize the floating distance of the magnetic head, to prevent adsorption of the magnetic head to the surface of the magnetic hard disc and further to improve the magnetic characteristics of the magnetic hard disc by providing it with a magnetic directionality in the peripheral direction, it has been known to provide approximately concentrically circular linear marks on the surface of the magnetic hard disc. If such linear marks contain abnormally high spots (referred to as abnormal protrusions), such spots will collide with the magnetic head. Thus, it is necessary to form these linear marks uniformly as well as finely over the entire surface of the magnetic hard disc.

In order to stabilize the magnetic head at a small floating distance (of less than 50 nm and further less than 20 nm) so as to prevent its adsorption and to improve its magnetic characteristics, it is now required to form line marks on the surface of the magnetic hard disc at a line density of greater than 40 lines/μm.

A magnetic hard disc is produced by polishing a magnetic hard disc substrate to form a mirror surface, thereafter forming concentric circular line marks referred to as textured marks on this surface of the magnetic hard disc substrate, and forming a magnetic layer and a protective layer on top thereof. The aforementioned line marks formed on the surface of the magnetic hard disc are approximately similar to the textured marks formed on the magnetic hard disc substrate. For this reason, the texturing process on the surface of the magnetic hard disc substrate is an important process in the production of magnetic hard discs.

As described in Japanese Patent Publications Tokkai 08-007266 and 11-161946, for example, the texturing process is carried out by supplying polishing slurry having polishing particles dispersed in water or a water-based aqueous solution on the surface of a rotating magnetic hard disc substrate and pressing a polishing tape of a woven, unwoven or raised plastic cloth thereon while continuing to unwind it.

Aluminum substrates with non-magnetic plating on the surface by alumite treatment or Ni—P plating used to be commonly used as the magnetic hard disc substrate but glass substrates with superior flatness, smoothness and rigidity are also coming to be widely used and, as described in Japanese Patent Publication Tokkai 06-150304, polishing slurry having diamond polishing particles dispersed therein is coming to be used for the texturing process of glass substrates which are harder than aluminum substrates.

It is generally known that finer textured line marks are obtainable by using polishing particles with smaller particle diameters and that more uniform textured line marks are obtainable by using polishing particles with uniform particle diameters. Japanese Patent Publication Tokkai 2000-136376 has proposed the use of diamond polishing particles for such a purpose made of artificially created diamond of diameters less than 20 nm obtained by a static pressure method (such as described in “Method of producing diamond and high-pressure technology” by Masanori Araki, Gijutsu Kaihatsu News No. 75, January, 1998 (http://www.chuden.co.jp/torikumi/kenkyu/news/pdf/075/NO7503.pdf)) by mechanically compressing carbon, melting it in a molten metallic catalyst under a high-pressure high-temperature condition and causing artificially created diamond to precipitate in a low-temperature portion. Diamond polishing particles are obtained by heating such artificially created diamond to convert the surface portion partially or entirely into non-diamond carbon. If they are used for the texturing process of the surface of a glass substrate, this non-diamond carbon portion covering the surface portion acts on the substrate surface and it is not possible to create fine textured line marks on the hard surface of the glass substrate at a line density of greater than 40 lines/μm.

### SUMMARY OF THE INVENTION

As explained above, it is being required to develop a technology of forming textured line marks clearly and uniformly on the surface of a magnetic hard disc at a line density greater than 40 lines/μm without leaving any abnormal protrusions such that the data recording capacity for a data processor such as a computer can be increased and the accuracy in playback can be improved.

It is therefore an object of this invention to provide diamond polishing particles capable of forming textured line marks clearly and uniformly on the surface of a magnetic hard disc at a line density greater than 40 lines/μm without leaving any abnormal protrusions, as well as a method of producing such diamond polishing particles.

Polishing particles according to this invention are characterized as comprising artificial diamond produced by a shock method, having density of 3.0-3.35 g/cm³ and including secondary particles with average particle diameter of 30 nm-500 nm. Such polishing particles may be produced according to this invention by firstly obtaining a product containing artificial diamond by a shock method, then subjecting this product to an acid treatment by using one or more strong acids selected from the group consisting of concentrated sulfuric acid, concentrated nitric acid and concentrated hydrochloric acid to thereby remove impurities from and wash the product, thereafter subjecting the product to a classification process to thereby separate artificial diamond of a first kind having secondary particles with particle diameters of 30 nm-500 nm and artificial diamond of a second kind having secondary particles with particle diameters in excess of 500 nm and selecting artificial diamond of a third kind having density of 3.0-3.35 g/cm³ out of the artificial diamond of the first kind. It is the artificial diamond of the third kind that is to be used as the diamond polishing particles according to this invention.

As the artificial diamond of the third kind is selected out of the artificial diamond of the first kind, artificial diamond of a fourth kind with density other than 3.0-3.35 g/cm³ may be further selected and the method of production according to this invention may further include the steps of mechanically crushing a mixture of the artificial diamond of the second kind and the artificial diamond of the fourth kind, subjecting this mixture to an acid treatment by using one or more strong acids selected from the group consisting of concentrated sulfuric acid, concentrated nitric acid and concentrated hydrochloric acid to thereby remove impurities from and wash the mixture, and thereafter subjecting the mixture to a classification process to thereby separate artificial diamond of the first kind having secondary particles with particle diameters of 30 nm-500 nm and artificial diamond of the second kind having secondary particles with particle diameters in excess of 500 nm. In the above, too, it is the artificial diamond of the third kind that is to be used as the diamond polishing particles according to this invention.

By using such diamond polishing particles according to this invention, it is possible to form clear textured line marks with small average surface roughness (Ra) and maximum protrusion height (Rmax) at line density greater than 40 lines/μm.

### BRIEF DESCRIPTION OF THE DRAWINGS

FIG. 1 is an enlarged (400,000 times) photograph of diamond polishing particles of this invention in the form of primary particles taken by a transmission electron microscope.

FIG. 2 is an enlarged (100,000 times) photograph of diamond polishing particles of this invention in the form of secondary particles taken by a scanning electron microscope.

FIG. 3 is a schematic drawing of a texturing apparatus.

### DETAILED DESCRIPTION OF THE INVENTION

This invention relates to diamond polishing particles suited to the texturing process on the surface of a magnetic hard disc substrate and adapted to be dispersed in polishing slurry. According to this invention, the surface of a magnetic hard disc and particularly the surface of a glass substrate of a hard material such as surface-hardened glass or crystallized glass can be textured to an average surface roughness (Ra) of 1 nm or less, or preferably 0.2-0.8 nm and the line density of textured line marks equal to 40 lines/μm or greater, or preferably equal to 60 lines/μm or greater.

The diamond polishing particles of this invention are made of artificially created diamond obtained by a shock method. In order to obtain the average surface roughness and line density on the magnetic hard disc, as described above, the density of artificially created diamond is within the range of 3.0-3.35 g/cm³ and the average diameter of the secondary particles of the diamond polishing particles is within the range of 30 nm-500 nm. The average diameter of the primary particles of the diamond polishing particles is equal to 20 nm or less.

To produce the diamond polishing particles of this invention, a product containing artificial diamond is created first by a shock method. The shock method is a technology of synthesizing diamond artificially by an exploding pressure of an explosive. Artificial diamond is created by a graphite shock compression method wherein a mixture of carbon (graphite) and metallic powder of iron and copper is compressed by a shock wave generated by the explosion of an explosive or an oxygen-less explosion method wherein an explosive such as TNT, RDX and HMX that can be used as a source of carbon is exploded inside a container filled with helium gas (as described, for example, by Eiji Osawa in “Nanodiamond and Oxygen-less Explosion Method” in Toryu Kako Gakkaishi, Vol. 47, No. 8, August, 2003 and Kotaro Hanada in “Cluster Diamond and Application to Solid Lubrication” in Toryu Kako Gakkaishi, Vol. 47, No. 8, August, 2003).

A product thus obtained contains, as impurities in addition to artificial diamond, metals such as iron and copper as well as carbon (graphite) which has not reacted. In order to remove these impurities, a strong acid such as one or more selected from the group consisting of concentrated sulfuric acid, concentrated nitric acid and concentrated hydrochloric acid is used for treatment. Metals such as copper, iron, silicon and lead and non-diamond carbon that are on the inner surfaces of cracks are thus removed from outside. Pure water or ion-exchange water is then used to wash five to seven times. Thereafter a centrifuge is used to completely remove the acid.

Next, a wet-type classification process is carried out to separate artificial diamond particles which are secondary particles with diameters in the range of 30 nm-500 nm from artificial diamond particles with diameters in excess of 500 nm. Particles of each class are separately filtered and dried. The density of the secondary particles from the dried and separated diamond particles with particle diameters in the range of 30 nm-500 nm is measured and those with density equal to or greater than 3.0 g/cm³ are used as diamond polishing particles.

Of the dried and separated diamond particles, those with particle diameters exceeding 500 nm and those with density less than 3.0 g/cm³ that were not used as diamond polishing particles are crushed in a ball mill. They are then treated again by using one or more strong acids selected from concentrated sulfuric acid, concentrated nitric acid and concentrated hydrochloric acid, washed, classified and separated into secondary particles with particle diameters in the range of 30 nm-500 nm and those with particle diameters in excess of 500 nm. These separated diamond particles are individually filtered and dried. Next, the density of these separated diamond particles with particle diameters in the range of 30 nm-500 nm is measured and those with density equal to or greater than 3.0 g/cm³ are used as diamond polishing particles.

Diamond particles with density less than 3.0 g/cm³ cannot form clear textured line marks on the surface of a glass substrate. This is probably because non-diamond carbon remains on the diamond surfaces and reacts with the glass surface. Moreover, artificial diamond particles with density less than 3.0 g/cm³ do not disperse well inside polishing slurry probably because the impurities are not sufficiently removed by the treatment with strong acids. For this reason, it is important to remove the impurities by a shock method to obtain artificial diamond with density no less than 3.0 g/cm³. On the other hand, an excessive acid treatment is required in order to produce artificial diamond with density in excess of 3.35 g/cm³ and the manpower and cost required for the production become excessive.

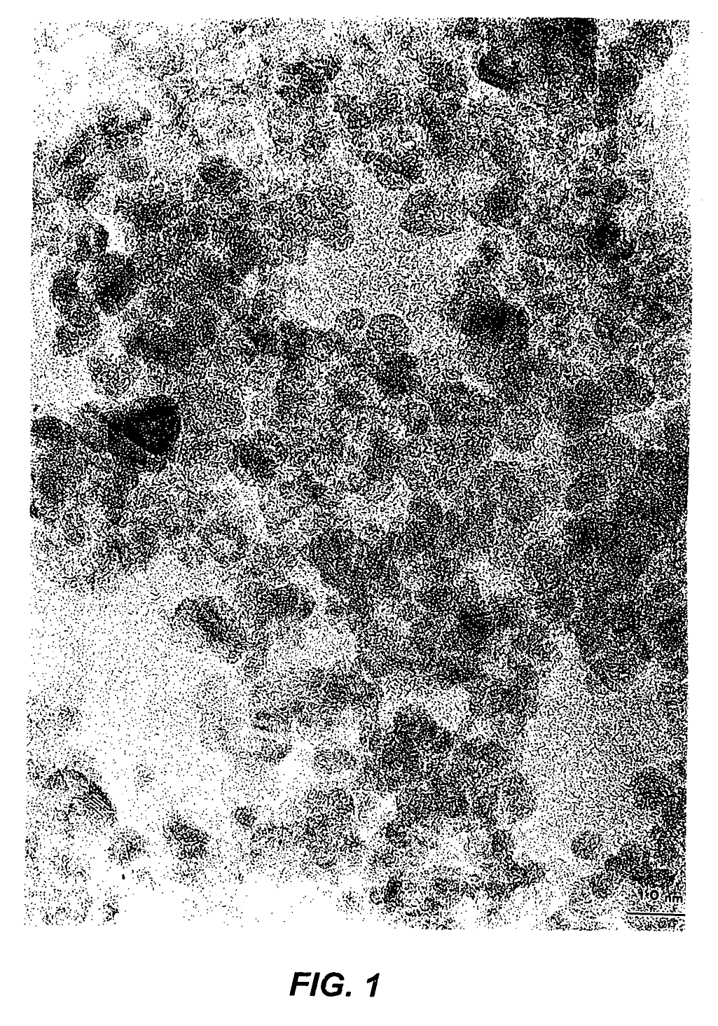

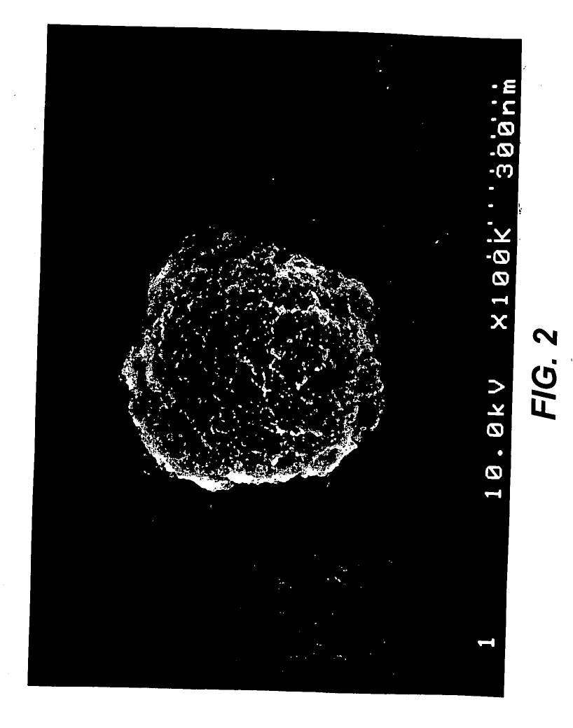

More than about 90% of the diamond polishing particles of this invention thus obtained are in the form of primary particles with particle diameters no greater than 20 nm, the rest (less than about 10%) being in the form of secondary particles with particle diameters in the range of 30 nm-500 nm. FIG. 1 is an enlarged (400,000 times) photograph of diamond polishing particles of this invention in the form of primary particles taken by a transmission electron microscope, and FIG. 2 is an enlarged (100,000 times) photograph of diamond polishing particles of this invention in the form of secondary particles taken by a scanning electron microscope.

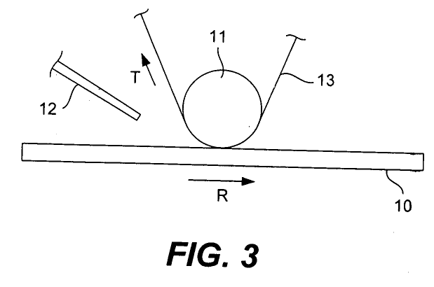

Diamond polishing particles of this invention are used for a texturing process on the surface of magnetic hard disc. As shown in FIG. 3, the texturing process is carried out by supplying through a nozzle 12 polishing slurry having polishing particles dispersed in water or a water-based aqueous solution on the surface of a magnetic hard disc 10 rotating in the direction of arrow R and pressing a polishing tape 13 thereon through a contact roller 11 while delivering it in the direction of arrow T.

The polishing slurry is obtained by dispersing diamond polishing particles of this invention in water or a water-based aqueous solution. An additive selected from non-ionic surfactant, organic ester of phosphoric acid, aliphatic amide, metallic salt of higher aliphatic acid and anionic surfactant may be added to the polishing slurry and a process may be carry out for increasing its viscosity and adjusting its pH value. A tape of a woven cloth, an unwoven cloth, a raised cloth or a cloth planted with hairs of a plastic material or a tape of foamed polyurethane may be used as the polishing tape. During the polishing process, the secondary particles contained in the diamond polishing particles of this invention act on the surface of the magnetic hard disc substrate while becoming decomposed.

The invention is described next by way of test examples.

### TEST EXAMPLE 1

A product containing artificial diamond was obtained by an oxygen-less explosion method with a TNT explosive exploded inside a container filled with a helium gas and this product was treated with concentrated sulfuric acid to remove from the outer surface of the product the impurities including metals such as copper, iron, silicon and lead and non-diamond carbon which existed inside open cracks. After it was washed and the acids were completely washed off by means of a centrifuge (continuous high-speed centrifuge Product No. H660 produced by Kokusan Kabushiki Kaisha), it was subjected to a wet classification process to separate the secondary (coagulated) particles into those having particle diameters of 30-500 nm and those having particle diameters in excess of 500 nm, each separated group of particles being then filtered and dried. In the above, the classification of artificial diamond (the product after the impurities were removed) was carried out firstly to the order of 1 μm by a levigation method (a method of stepwise classification by using difference in speed of sinking in water due to difference in specific weight and particle diameter) and finally to the level of submicron particles by a wet-type centrifugation method.

Of the dried and separated particles, the density of artificial diamond with particle diameters of secondary particles in the range of 30 nm-500 nm was measured (by using dry-type automatic density meter using helium gas (Product name Accupyc 1330 produced by Shimadzu Seisakusho)) and those with density 3.28 g/cm³ were used as diamond polishing particles of Test Example 1.

Artificial diamond with density other than 3.28 g/cm³ and the secondary particles with particle diameters equal to or greater than 500 nm were crushed in a ball mill and after they were treated with a strong acid such as concentrated sulfuric acid and washed, they were classified as described above to separate the secondary particles into a group of those with particle diameters in the range of 30 nm-500 nm and another group of those with particle diameters equal to or greater than 500 nm. Particles of each group were filtered, and artificial diamond with density equal to 3.28 g/cm³ were used as diamond polishing particles of Test Example 1. The average diameter of the primary particles of the diamond polishing particles of Test Example 1 thus obtained was 10 nm and that of the secondary particles was 200 nm.

### TEST EXAMPLE 2

A product containing artificial diamond was obtained by an oxygen-less explosion method with a TNT explosive exploded inside a container filled with a helium gas, as done in Test Example 1, and this product was treated with concentrated sulfuric acid to remove from the outer surface of the product the impurities including metals such as copper, iron, silicon and lead and non-diamond carbon which existed inside open cracks. After it was washed and the acids were completely washed off by means of a centrifuge, it was subjected to a wet classification process to separate the secondary (coagulated) particles into those having particle diameters of 30-500 nm and those having particle diameters in excess of 500 nm, each separated group of particles being then filtered and dried. Of the dried and separated particles, the density of artificial diamond with particle diameters of secondary particles in the range of 30 nm-500 nm was measured and those with density 3.25 g/cm³ were used as diamond polishing particles of Test Example 2.

Artificial diamond with density other than 3.25 g/cm³ and the secondary particles with particle diameters equal to or greater than 500 nm were crushed in a ball mill and after they were treated with a strong acid such as concentrated sulfuric acid and washed, they were classified as described above to separate the secondary particles into a group of those with particle diameters in the range of 30 nm-500 nm and another group of those with particle diameters equal to or greater than 500 nm. Particles of each group were filtered, and artificial diamond with density equal to 3.25 g/cm³ were used as diamond polishing particles of Test Example 2. The average diameter of the primary particles of the diamond polishing particles of Test Example 2 thus obtained was 10 nm and that of the secondary particles was 200 nm.

### TEST EXAMPLE 3

A product containing artificial diamond was obtained by an oxygen-less explosion method with a TNT explosive exploded inside a container filled with a helium gas, as done in Test Example 1, and this product was treated with concentrated sulfuric acid to remove from the outer surface of the product the impurities including metals such as copper, iron, silicon and lead and non-diamond carbon which existed inside open cracks. After it was washed and the acids were completely washed off by means of a centrifuge, it was subjected to a wet classification process to separate the secondary (coagulated) particles into those having particle diameters of 30-500 nm and those having particle diameters in excess of 500 nm, each separated group of particles being then filtered and dried. Of the dried and separated particles, the density of artificial diamond with particle diameters of secondary particles in the range of 30 nm-500 nm was measured and those with density 3.10 g/cm³ were used as diamond polishing particles of Test Example 3.

Artificial diamond with density other than 3.10 g/cm³ and the secondary particles with particle diameters equal to or greater than 500 nm were crushed in a ball mill and after they were treated with a strong acid such as concentrated sulfuric acid and washed, they were classified as described above to separate the secondary particles into a group of those with particle diameters in the range of 30 nm-500 nm and another group of those with particle diameters equal to or greater than 500 nm. Particles of each group were filtered, and artificial diamond with density equal to 3.10 g/cm³ were used as diamond polishing particles of Test Example 3. The average diameter of the primary particles of the diamond polishing particles of Test Example 3 thus obtained was 10 nm and that of the secondary particles was 200 nm.

### COMPARISON EXAMPLE 1

A product containing artificial diamond was obtained by an oxygen-less explosion method with a TNT explosive exploded inside a container filled with a helium gas, as done in Test Examples 1-3, and this product was treated with concentrated sulfuric acid to remove from the outer surface of the product the impurities including metals such as copper, iron, silicon and lead and non-diamond carbon which existed inside open cracks. After it was washed and the acids were completely washed off by means of a centrifuge, it was subjected to a wet classification process to separate the secondary (coagulated) particles into those having particle diameters of 30-500 nm and those having particle diameters in excess of 500 nm, each separated group of particles being then filtered and dried. Of the dried and separated particles, the density of artificial diamond with particle diameters of secondary particles in the range of 30 nm-500 nm was measured and those with density 2.88/cm³ were used as diamond polishing particles of Comparison Example 1.

Artificial diamond with density other than 2.88 g/cm³ and the secondary particles with particle diameters equal to or greater than 500 nm were crushed in a ball mill and after they were treated with a strong acid such as concentrated sulfuric acid and washed, they were classified as described above to separate the secondary particles into a group of those with particle diameters in the range of 30 nm-500 nm and another group of those with particle diameters equal to or greater than 500 nm. Particles of each group were filtered, and artificial diamond with density equal to 2.88 g/cm³ were used as diamond polishing particles of Comparison Example 1. The average diameter of the primary particles of the diamond polishing particles of Test Example thus obtained was 10 nm and that of the secondary particles was 200 nm.

### COMPARISON EXAMPLE 2

A product containing artificial diamond was obtained by an oxygen-less explosion method with a TNT explosive exploded inside a container filled with a helium gas, as done in Test Examples 1-3, and this product was treated with concentrated sulfuric acid to remove from the outer surface of the product the impurities including metals such as copper, iron, silicon and lead and non-diamond carbon which existed inside open cracks. After it was washed and the acids were completely washed off by means of a centrifuge, it was subjected to a wet classification process to separate the secondary (coagulated) particles into those having particle diameters of 30-500 nm and those having particle diameters in excess of 500 nm, each separated group of particles being then filtered and dried. Of the dried and separated particles, the density of artificial diamond with particle diameters of secondary particles in the range of 30 nm-500 nm was measured and those with density 2.45/cm³ were used as diamond polishing particles of Comparison Example 2.

Artificial diamond with density other than 2.45 g/cm³ and the secondary particles with particle diameters equal to or greater than 500 nm were crushed in a ball mill and after they were treated with a strong acid such as concentrated sulfuric acid and washed, they were classified as described above to separate the secondary particles into a group of those with particle diameters in the range of 30 nm-500 nm and another group of those with particle diameters equal to or greater than 500 nm. Particles of each group were filtered, and artificial diamond with density equal to 2.45 g/cm³ were used as diamond polishing particles of Comparison Example 2. The average diameter of the primary particles of the diamond polishing particles of Comparison Example 2 thus obtained was 10 nm and that of the secondary particles was 200 nm.

### COMPARISON EXAMPLE 3

A product containing artificial diamond was obtained by an oxygen-less explosion method with a TNT explosive exploded inside a container filled with a helium gas, as done in Test Examples 1-3, and this product was treated with concentrated sulfuric acid to remove from the outer surface of the product the impurities including metals such as copper, iron, silicon and lead and non-diamond carbon which existed inside open cracks. After it was washed and the acids were completely washed off by means of a centrifuge, it was subjected to a wet classification process to separate the secondary (coagulated) particles into those having particle diameters of 30-500 nm and those having particle diameters in excess of 500 nm, each separated group of particles being then filtered and dried. Of the dried and separated particles, the density of artificial diamond with particle diameters of secondary particles in the range of 30 nm-500 nm was measured and those with density 2.20/cm³ were used as diamond polishing particles of Comparison Example 3.

Artificial diamond with density other than 2.20 g/cm³ and the secondary particles with particle diameters equal to or greater than 500 nm were crushed in a ball mill and after they were treated with a strong acid such as concentrated sulfuric acid and washed, they were classified as described above to separate the secondary particles into a group of those with particle diameters in the range of 30 nm-500 nm and another group of those with particle diameters equal to or greater than 500 nm. Particles of each group were filtered, and artificial diamond with density equal to 2.20 g/cm³ were used as diamond polishing particles of Comparison Example 3. The average diameter of the primary particles of the diamond polishing particles of Comparison Example 3 thus obtained was 10 nm and that of the secondary particles was 200 nm.

### COMPARISON TEST

Diamond polishing particles of Test Examples 1-3 and Comparison Examples 1-3 thus produced were used to prepare polishing slurry samples. Each of these slurry samples thus prepared was used to texture the surface of a magnetic hard disk substrate and the average surface roughness (Ra), the maximum height (Rmax) and the line density of the textured line marks on the glass surface after the texturing process were compared. The average surface roughness (Ra) and maximum height (Rmax) on the surface of each glass substrate after the texturing process were measured by means of a scanning electron microscope. The line density of textured line marks on each surface was measured from a computer image photograph.

Glass substrates of 2.5 inches with a mirror-polished surface undergoing a surface hardening process were used as magnetic hard discs for the test. Their average surface roughness (Ra) before the texturing process was 0.1 nm-0.2 nm.

The polishing slurry samples were prepared by adding each of the diamond polishing particles of Test Examples 1-3 and Comparison Examples 1-3 into pure water and dispersed by ultrasonic vibrations and having a glycol compound added as an additive and dispersed by ultrasonic vibrations. The composition of the polishing slurry samples was as shown in Table 1 below. The dispersion characteristics of the polishing slurry samples with artificial diamond polishing particles of Comparison Examples 1-3 with density equal to or less than 3 g/cm³ were poorer than those of the polishing slurry samples with artificial diamond polishing particles of Test Examples 1-3 with density equal to or greater than 3 g/cm³.

TABLE 1

| | | |
|---|---|---|
| Diamond polishing | 0.05 | weight % |
| particles | | |
| Additive | 5 | weight % |
| Water | 94.95 | weight % |

The texturing process was carried out by using a conventional texturing apparatus shown in FIG. 3 under the conditions shown in Table 2.

TABLE 2

| | | |
|---|---|---|
| Rotary speed of glass substrate | 300 | rpm |
| Travel speed of tape | 6 | cm/minute |
| Supply rate of polishing slurry | 15 | cc/minute |
| Hardness of contact roller (rubber) | 45 | duro |
| Oscillation width | 5 | Hz (1 mm) |
| Pressure of compression by contact roller | 4.5 | kg |
| Processing time | 15-30 | seconds |

Use as the polishing tape was made of a tape of a woven cloth of thickness 700 μm made of polyester fibers of thickness about 1 μm.

### RESULTS OF COMPARISON TEST

Table 3 shows the results of the comparison test carried out by using the diamond polishing particles of Test Examples 1-3 and Comparison Examples 1-3.

TABLE 3

| | | | Den- | | | | |
|---|---|---|---|---|---|---|---|
| | | | sity | | | | |
| | | | of | | | | |
| | Average | Average | arti- | | | | |
| | diameter | diameter | ficial | | | | |
| | of | of | dia- | | | Line | Tex- |
| | primary | secondary | mond | | | density | tured |
| | particles | particles | (g/ | Ra | Rmax | (lines/ | line |
| | (nm) | (nm) | cm³) | (nm) | (nm) | μm) | marks |
| Test | 10 | 200 | 3.28 | 0.5 | 1.0 | 70 | Clear |
| Exam- | | | | | | | |
| ple 1 | | | | | | | |
| Test | 10 | 200 | 3.35 | 0.8 | 1.2 | 75 | Clear |
| Exam- | | | | | | | |
| ple 2 | | | | | | | |
| Test | 10 | 200 | 3.10 | 0.4 | 0.8 | 60 | Clear |
| Exam- | | | | | | | |
| ple 3 | | | | | | | |
| Com- | 10 | 200 | 2.88 | 0.2 | 0.6 | 35 | Some- |
| parison | | | | | | | what |
| Exam- | | | | | | | unclear |
| ple 1 | | | | | | | |
| Com- | 25 | 200 | 2.45 | <0.2 | 0.3 | 30 | Unclear |
| parison | | | | | | | |
| Exam- | | | | | | | |
| ple 2 | | | | | | | |
| Com- | 28 | 200 | 2.10 | 2.4 | 2.5 | *1 | Unclear |
| parison | | | | | | | |
| Exam- | | | | | | | |
| ple 3 | | | | | | | |

In TABLE 3:
*1 Not measurable

Table 3 clearly shows that Test Examples 1, 2 and 3 embodying this invention can form clear textured line marks with small average surface roughness (Ra) and maximum protrusion height (Rmax) and much greater line densities of more than 60 lines/μm (more than twice as great as by Comparison Examples). This indicates that clear textured line marks with small average surface roughness (Ra) and maximum protrusion height (Rmax) can be formed at line density greater than 40 lines/μm by using artificial diamond polishing particles with particle diameters of secondary particles in the range of 30 nm-500 nm and density in the range of 3.0-3.35 g/cm³.

It now goes without saying that the diamond polishing particles according to this invention can be used effectively not only for the texturing process on the surface of a glass substrate but also on the surface of an aluminum substrate. The diamond polishing particles of this invention may be used not only for the texturing but also for the polishing process.

1. Polishing particles comprising artificial diamond produced by a shock method, said artificial diamond having density of 3.0-3.35 g/cm³ and including secondary particles with average particle diameter of 30 nm-500 nm.

2. The polishing particles of claim 1 wherein the density of said artificial diamond is 3.2-3.35 g/cm³.

3. The polishing particles of claim 1 including primary particles with average particle diameter equal to or less than 20 nm.

4. A method of producing diamond polishing particles, said method comprising the steps of:
obtaining a product containing artificial diamond by a shock method;
subjecting said product to an acid treatment by using one or more strong acids selected from the group consisting of concentrated sulfuric acid, concentrated nitric acid and concentrated hydrochloric acid to thereby remove impurities from said product and wash said product;
thereafter subjecting said product to a classification process to thereby separate artificial diamond of a first kind having secondary particles with particle diameters of 30 nm-500 nm and artificial diamond of a second kind having secondary particles with particle diameters in excess of 500 nm;
selecting artificial diamond of a third kind having density of 3.0-3.35 g/cm³ out of said artificial diamond of the first kind; and
using said artificial diamond of the third kind as diamond polishing particles.

5. The method of claim 4 wherein the step of selecting artificial diamond of the third kind out of the artificial diamond of the first kind includes the step of selecting artificial diamond of a fourth kind with density other than 3.0-3.35 g/cm³;
said method further comprising the steps of:
mechanically crushing a mixture of said artificial diamond of the second kind and said artificial diamond of the fourth kind;
subjecting said mixture to an acid treatment by using one or more strong acids selected from the group consisting of concentrated sulfuric acid, concentrated nitric acid and concentrated hydrochloric acid to thereby remove impurities from said mixture and wash said mixture; and
thereafter subjecting said mixture to a classification process to thereby separate artificial diamond of the first kind having secondary particles with particle diameters of 30 nm-500 nm and artificial diamond of the second kind having secondary particles with particle diameters in excess of 500 nm.
